(19) United States
(12) Patent Application Publication
(10) Pub. No.: US 2017/0153503 A1
(43) Pub. Date: Jun. 1, 2017

(54) BLUE PHASE LIQUID CRYSTAL DISPLAY PANEL

(71) Applicant: Wuhan China Star Optoelectronics Technology Co., Ltd., Wuhan, Hubei (CN)

(72) Inventor: Yuejun Tang, Wuhan, Hubei (CN)

(73) Assignee: Wuhan China Star Optoelectronics Technology Co., Ltd., Wuhan, Hubei (CN)

(21) Appl. No.: 14/786,043

(22) PCT Filed: Jun. 26, 2015
(86) PCT No.: PCT/CN2015/082531

§ 371 Date: Dec. 13, 2016

(30) Foreign Application Priority Data
Jun. 12, 2015 (CN) 201510324112.7

(51) Int. Cl. G02F 1/1337; G02F 1/1333; G02F 1/1343

(52) U.S. Cl. CPC G02F 1/133707; G02F 1/134363; G02F 1/133345; G02F 2201/123; G02F 2201/121; G02F 2202/02

(57) ABSTRACT

A blue phase liquid crystal display panel is disclosed. The blue phase liquid crystal display panel comprises an upper substrate and a lower substrate, wherein the lower substrate and the upper substrate are provided with a first curved film layer and a second curved film layer matching with each other respectively. In the blue phase liquid crystal display panel, a thickness of a liquid crystal layer is reduced, a strength of a horizontal electric field is increased, and a driving voltage of the blue phase liquid crystal is reduced.

### CROSS REFERENCE TO RELATED APPLICATION

The present application claims benefit of Chinese patent application CN 201510324112.7, entitled “Blue Phase Liquid Crystal Display Panel” and filed on Jun. 12, 2015, the entirety of which is incorporated herein by reference.

### FIELD OF THE INVENTION

The present disclosure relates to the technical field of liquid crystal display device, and particularly to a blue phase liquid crystal display panel.

### BACKGROUND OF THE INVENTION

Compared with the liquid crystal materials that are widely used at present, blue phase liquid crystal has various prominent advantages. For example, the blue phase liquid crystal has a fast response speed. The blue phase liquid crystal generally has a sub-millisecond level response time. Since the blue phase liquid crystal is optically isotropic in dark fields, the blue phase liquid crystal has a wide viewing angle with a good symmetry. In addition, when a thickness of a liquid crystal cell of a blue phase liquid crystal display device is larger than a certain value, the penetrability of the blue phase liquid crystal is not sensitive to the thickness of the liquid crystal cell. Therefore, the blue phase liquid crystal is especially suitable for manufacturing large-sized display screen.

However, the over high driving voltage of the blue phase liquid crystal has restricted its development seriously. The blue phase liquid crystal needs to be driven by a horizontal electric field. However, the strength of the horizontal electric field is limited since the electrodes which are used for generating the horizontal electric field are usually arranged on one single substrate. Therefore, a relatively high driving voltage should be provided so that a satisfactory electric field can be obtained to drive the blue phase liquid crystal.

In a word, in order to solve the aforesaid technical problem, a method through which the driving voltage of the blue phase liquid crystal can be effectively reduced is urgently needed.

### SUMMARY OF THE INVENTION

The present disclosure aims to provide a method through which the driving voltage of the blue phase liquid crystal can be effectively reduced.

In order to solve the aforesaid technical problem, the embodiments of the present disclosure provide a blue phase liquid crystal display panel, comprising an upper substrate and a lower substrate, wherein the lower substrate and the upper substrate are respectively provided with a first curved film layer and a second curved film layer matching with each other, and the first curved film layer and the second curved film layer are provided with protrusions and depressions arranged alternately on two opposite surfaces thereof, the two opposite surfaces being parallel with each other; wherein pixel electrodes are arranged between the first curved film layer and the second curved film layer, and a common electrode is arranged inside the first curved film layer or the second curved film layer; or wherein the common electrodes and the pixel electrodes are arranged between the first curved film layer and the second curved film layer alternately.

Preferably, the curved film layer is a wave-shaped curved film layer, a triangular teeth-shaped curved film layer, and/or a trapezoid teeth-shaped curved film layer.

Preferably, the pixel electrodes are arranged on surfaces of protrusions or depressions of the first curved film layer, and the common electrode is arranged inside the first curved film layer.

Preferably, the pixel electrodes are arranged on inclined surfaces at two sides of protrusions or depressions of the first curved film layer, and the common electrode is arranged inside the first curved film layer.

Preferably, the pixel electrodes and the common electrodes are arranged on surfaces of protrusions or depressions of the first curved film layer alternately.

Preferably, the pixel electrodes and the common electrodes are arranged on inclined surfaces at two sides of protrusions or depressions of the first curved film layer alternately.

Preferably, the pixel electrodes are arranged on surfaces of protrusions of the first curved film layer, and the common electrodes are arranged on surfaces of protrusions of the second curved film layer correspondingly.

Preferably, the first curved film layer is formed by an organic film layer through patterning.

Preferably, the curved film layer is made of SiNₓ, SiO₂, or organic resin.

Preferably, the curved film layer is formed by a multi-tone photomask through patterning; and the protrusions of the curved film layer are formed by density regulation regions of the multi-tone photomask through patterning, and the depressions of the curved film layer are formed by size regulation regions of the multi-tone photomask through patterning.

Compared with the prior art, one embodiment or a plurality of embodiments according to the present disclosure may have the following advantages or beneficial effects.

A thickness of a liquid crystal layer can be reduced through arranging curved film layers on both the upper substrate and the lower substrate. In this case, a distance between the electrodes can be reduced, a surface area of each electrode can be increased, and thus the directly opposite area between the electrodes can be improved. Therefore, the strength of the horizontal electric field can be improved, and thus a driving voltage of the blue phase liquid crystal can be reduced.

Other advantages, objectives, and features of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure or the prior art, and constitute one part of the description. The drawings are used for interpreting the present disclosure together with the embodiments, not for limiting the present disclosure. In the drawings:

FIG. 1(a) to FIG. 1(c) each schematically show a structure of a curved film layer according to an embodiment of the present disclosure, wherein FIG. 1(a) schematically shows a structure of a wave-shaped film layer, FIG. 1(b) schematically shows a structure of a trapezoid teeth-shaped film layer, and FIG. 1(c) schematically shows a structure of a triangular teeth-shaped film layer;

FIG. 2 schematically shows a structure of a blue phase liquid crystal display panel according to embodiment 1 of the present disclosure;

FIG. 3 schematically shows a structure of a blue phase liquid crystal display panel according to embodiment 2 of the present disclosure;

FIG. 4 schematically shows a structure of a blue phase liquid crystal display panel according to embodiment 3 of the present disclosure;

FIG. 5 schematically shows a structure of a blue phase liquid crystal display panel according to embodiment 4 of the present disclosure;

FIG. 6 schematically shows a structure of a blue phase liquid crystal display panel according to embodiment 5 of the present disclosure;

FIG. 7 is a flow chart of a method for manufacturing a substrate of a blue phase liquid crystal display panel according to an embodiment of the present disclosure; and

FIG. 8 schematically shows a structure of a multi-tone photomask according to an embodiment of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

According to the present disclosure, the driving voltage of the blue phase liquid crystal can be reduced through increasing the strength of the electric field. The strength of the electric field can be increased through various methods, for example, increasing a surface area of each electrode, increasing the directly opposite area between the electrodes, reducing the distance between the electrodes, and so on. With respect to the liquid crystal display device that is driven by a horizontal electric field, the strength of the electric field can also be increased through reducing a distance between the two substrates.

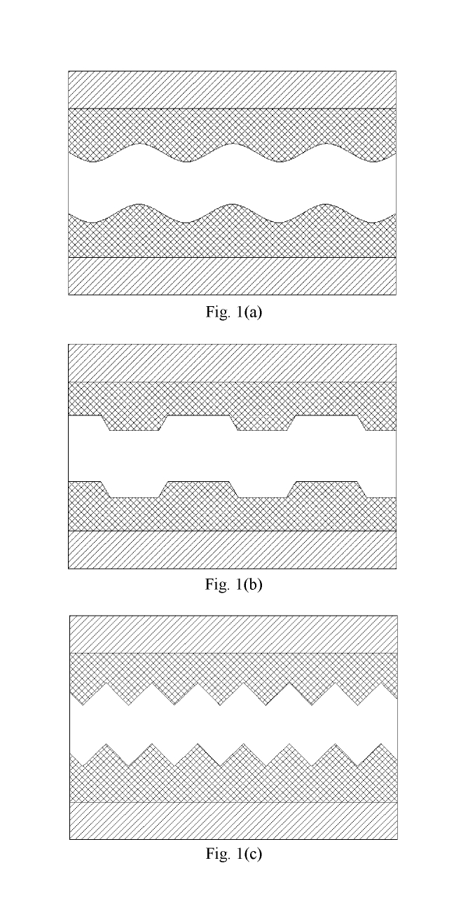

According to a traditional method for driving the blue phase liquid crystal with the horizontal electric field, pixel electrodes and common electrodes are arranged on one single substrate alternately. The strength of the horizontal electric field generated according to this method is relatively strong in an area near to the substrate on which the electrodes are arranged, but is relatively weak in an area near to another substrate that is opposite to the substrate on which the electrodes are arranged. The strength of the electric field in the area near to another substrate that is opposite to the substrate on which the electrodes are arranged can be increased through reducing the distance between the two substrates. However, during practical applications, the distance between the upper substrate and the lower substrate of the liquid crystal display panel that is driven by the horizontal electric field, i.e., a thickness of a liquid crystal cell should meet a certain requirement in order to obtain a relatively high penetration. Therefore, the distance between the upper substrate and the lower substrate of the liquid crystal display panel cannot be reduced excessively. The strength of the electric field thereof should be increased through other methods, for example, increasing a height of the electrode. The manufacturing procedure of the electrode with a large height is complex, and thus in actual situations the blue phase liquid crystal generally needs a relatively high driving voltage. According to the embodiments of the present disclosure, in order to reduce the driving voltage of the blue phase liquid crystal so that the area near to another substrate that is opposite to the substrate on which the electrodes are arranged can obtain an enough electric field strength, the lower substrate and the upper substrate are provided with a first curved film layer and a second curved film layer respectively on inside surfaces thereof. The first curved film layer and the second curved film layer each are provided with protrusions and depressions arranged alternately on two opposite surfaces thereof, and the protrusions and depressions formed on one of the first curved film layer and the second curved film layer match with the depressions and protrusions formed on the other one of the first curved film layer and the second curved film layer. Further, the first curved film layer and the second curved film layer are parallel to each other, i.e., a distance of one point of the first curved film layer to the second curved film layer is equal to a distance of any other point of the first curved film layer to the second curved film layer, as shown in FIG. 1.

FIG. 1(a) to FIG. 1(c) each schematically show a structure of a curved film layer according to the embodiment of the present disclosure, wherein FIG. 1(a) schematically shows a structure of a wave-shaped film layer, FIG. 1(b) schematically shows a structure of a trapezoid teeth-shaped film layer, and FIG. 1(c) schematically shows a structure of a triangular teeth-shaped film layer. The wave-shaped film layer is a preferred solution. Since the wave-shaped film layer has a continuously changing curvature, a uniform electric field can be formed in a space that is filled with the blue phase liquid crystal. It should be noted that, the aforesaid film layer structures are only specific examples for the structure of the film layer, not used for limiting the structure of the film layer according to the present disclosure.

It can be seen from FIG. 1(a) to FIG. 1(c) that, the distance between the upper substrate and the lower substrate can be reduced by the curved film layers provided therein, and the liquid crystal layer has a uniform thickness. In this case, the electric field in the area near to another substrate that is opposite to the substrate on which the electrodes are arranged can be strengthened, and thus the driving voltage of the blue phase liquid crystal can be reduced. Meanwhile, it can be seen from a curve showing the relationship between the penetration and the driving voltage that, when the blue phase liquid crystal layer has a uniform thickness, the curve of the penetration and the driving voltage has a maximum value. That is, the thickness of the liquid crystal layer has an optimized value. With respect to the liquid crystal display device with a non-uniform liquid crystal layer, since the best penetration cannot be obtained at a position less than or larger than the optimized thickness of the liquid crystal layer, the optimized value of the thickness of the liquid crystal layer cannot be obtained. When the liquid crystal layer has a uniform thickness, the thickness can be selected to be the optimized value. Therefore, according to the embodiment of the present disclosure, the display effect of the liquid crystal display device can be improved, and thus a more uniform image can be obtained.

The structure of the liquid crystal display panel will be illustrated in detail hereinafter with reference to specific embodiments, and the wave-shaped curved film layer is taken as an example.

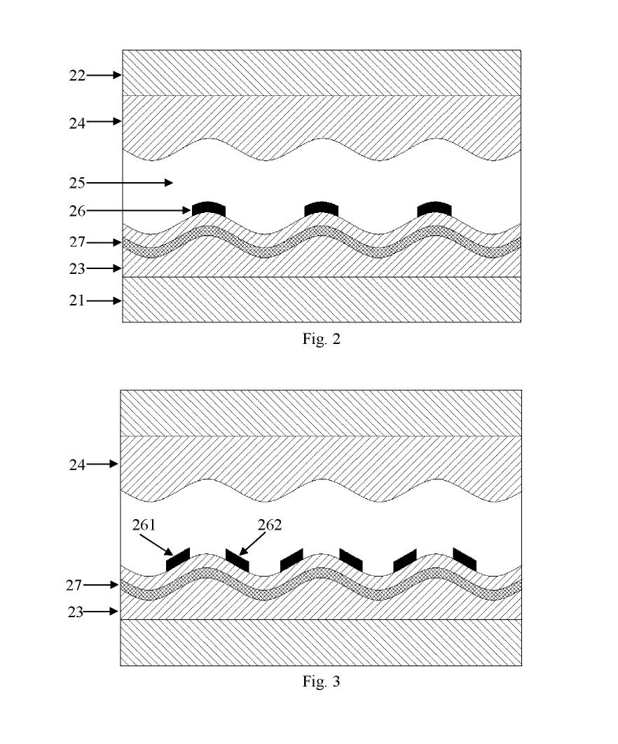

FIG. 2 schematically shows a structure of the blue phase liquid crystal display panel according to embodiment 1 of the present disclosure. As shown in FIG. 2, a lower substrate 21, which corresponds to an array substrate, is generally provided with pixel units, data lines and scanning lines. An upper substrate 22, which corresponds to a color filter substrate, is generally provided with a black matrix and a color filter. The specific implementations of the present embodiment would not be affected by the aforesaid structures of the array substrate and the color filter substrate. Therefore, the structures prefabricated on the lower substrate (i.e., the array substrate) and the upper substrate (i.e., the color filter substrate) are not limited herein, and not shown in FIG. 2. The lower substrate 21 is provided with a first wave-shaped film layer 23, and the upper substrate 22 is provided with a second wave-shaped film layer 24. Since the first wave-shaped film layer 23 and the second wave-shaped film layer 24 are parallel to each other, a space 25 with a uniform thickness can be formed between the first wave-shaped film layer 23 and the second wave-shaped film layer 24.

Further, pixel electrodes 26 are arranged on surfaces of protrusions of the first wave-shaped film layer, and a common electrode 27 is arranged inside the first wave-shaped film layer. The pixel electrodes and the common electrode are all arranged with a shape matching the wave-shaped film layer. Compared with the prior art, a surface area of each electrode can be increased by the curved shape thereof, a strength of an electric field between the pixel electrodes and the common electrode can be improved, and thus the driving voltage of the blue phase liquid crystal can be reduced.

It should be noted that, the present embodiment can also be implemented if the pixel electrodes 26 are arranged on surfaces of depressions of the first wave-shaped film layer 23, or on surfaces of both protrusions and depressions of the first wave-shaped film layer 23, and the common electrode 27 is still arranged inside the first wave-shaped film layer 23. It can be understood that, the present embodiment can also be implemented if the pixel electrodes 26 are arranged on the surface of the second wave-shaped film layer 24 in a similar manner and the common electrode 27 is arranged inside the second wave-shaped film layer 24 accordingly.

FIG. 3 schematically shows a structure of the blue phase liquid crystal display panel according to embodiment 2 of the present disclosure. According to the present embodiment, each pixel electrode extends from a protrusion of the first wave-shaped film layer 23 to the inclined surfaces at the two sides of the protrusion, and the pixel electrode is divided into two parts, i.e., a pixel electrode 261 and a pixel electrode 262 at the protrusion of the first wave-shaped film layer 23. Compared with the arrangement of the pixel electrodes in the previous embodiment, the pixel electrode 261 and the pixel electrode 262 are arranged at the two sides of the protrusion of the first wave-shaped film layer 23 respectively, and thus in a state similar to a vertical state. In this manner, it is equal to that the directly opposite area between the electrodes can be increased. Therefore, a horizontal component of the electric field between the pixel electrode 261 and the common electrode 27 can be increased, i.e., the horizontal electric field can be increased. Similarly, a horizontal electric field between the pixel electrode 262 and the common electrode 27 can also be increased, and thus the driving voltage of the blue phase liquid crystal can be further reduced.

It should be noted that, the present embodiment can also be implemented if the pixel electrodes 261 and 262 are arranged on inclined surfaces at two sides of depressions of the first wave-shaped film layer 23, or on inclined surfaces at two sides of both protrusions and depressions of the first wave-shaped film layer 23, and the common electrode 27 is still arranged inside the first wave-shaped film layer 23. It can be understood that, the present embodiment can also be implemented if the pixel electrodes 261 and 262 are arranged on the surface of the second wave-shaped film layer 24 in a similar manner and the common electrode 27 is arranged inside the second wave-shaped film layer 24 accordingly.

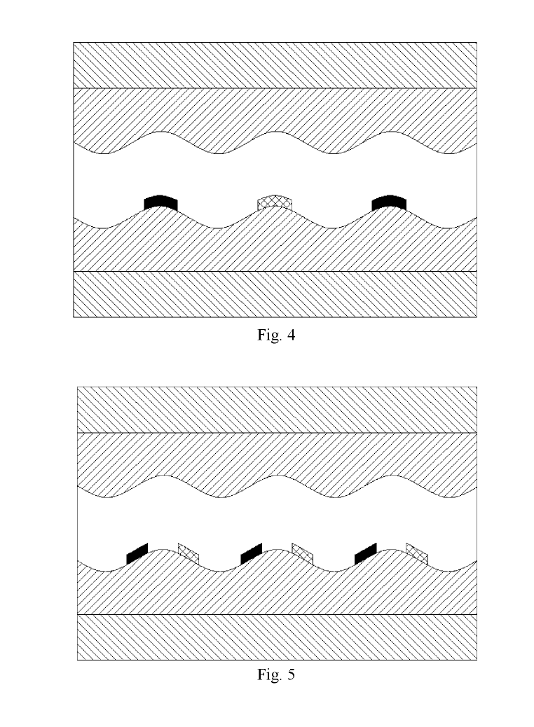

FIG. 4 schematically shows a structure of the blue phase liquid crystal display panel according to embodiment 3 of the present disclosure. According to the present embodiment, the pixel electrodes and the common electrodes are arranged on surfaces of protrusions or depressions of the first wave-shaped film layer alternately, or on surfaces of both protrusions and depressions of the first wave-shaped film layer alternately. It can be understood that, the present embodiment can also be implemented if the pixel electrodes and the common electrodes are arranged on surfaces of protrusions or depressions of the second wave-shaped film layer alternately, or on surfaces of both protrusions and depressions of the second wave-shaped film layer alternately. Further, the directly opposite area between the pixel electrodes and the common electrodes can be increased if the two wings of each electrode extend from the protrusion or depression of the wave-shaped film layer to the inclined surfaces at the two sides thereof. In this case, the horizontal electric field can be strengthened, and thus the driving voltage of the blue phase liquid crystal can be reduced.

FIG. 5 schematically shows a structure of the blue phase liquid crystal display panel according to embodiment 4 of the present disclosure. According to the present embodiment, the electrode extends from a protrusion or a depression of the first wave-shaped film layer to the inclined surfaces at the two sides thereof, and the two electrodes which are separated from each other at the protrusion or the depression are arranged to be a pixel electrode and a common electrode alternately. It can be understood that, the present embodiment can also be implemented if the aforesaid structure is arranged on the second wave-shaped film layer. It can be seen from FIG. 5 that, a fringe electric field can be formed between the pixel electrode and the common electrode at each protrusion of the wave-shaped film layer, so that the horizontal electric field in the space can be strengthened. The directly opposite area between the pixel electrode and the common electrode can be increased on inclined surfaces at the two sides of the protrusions and depressions of the wave-shaped film layer. Therefore, the horizontal electric field in the space can be further strengthened, and thus the driving voltage of the blue phase liquid crystal can be significantly reduced.

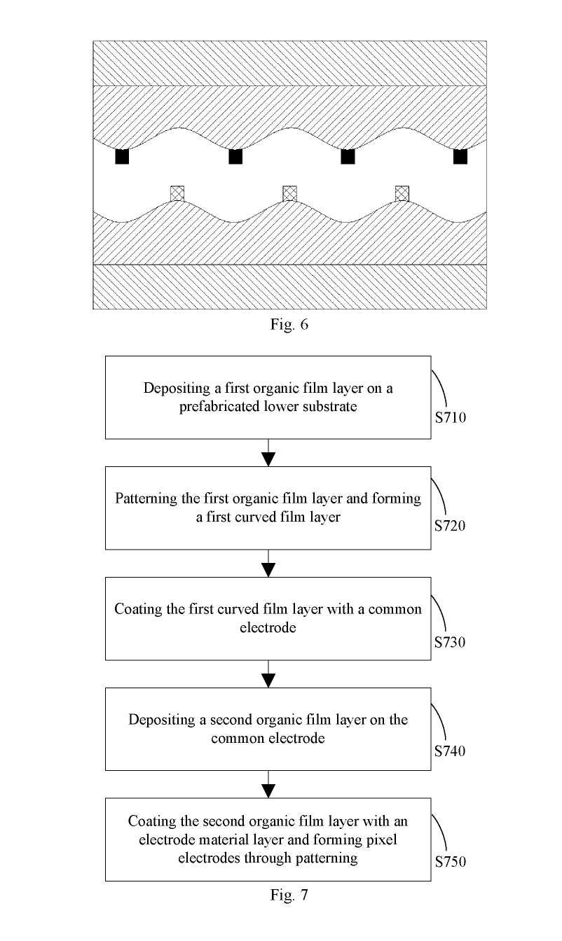

FIG. 6 schematically shows a structure of the blue phase liquid crystal display panel according to embodiment 5 of the present disclosure. According to the present embodiment, the electrodes are arranged on the surface of the first wave-shaped film layer and the surface of the second wave-shaped film layer at the same time. As shown in FIG. 6, the pixel electrodes are arranged at the protrusions of the second wave-shaped film layer (or the first wave-shaped film layer), and the common electrodes are arranged at the protrusions of the first wave-shaped film layer (or the second wave-shaped film layer) accordingly. Since the distance between the electrodes can be reduced by the wave-shaped film layers, the electric field between the electrodes that are arranged on the first wave-shaped film layer and the second wave-shaped film layer respectively can be strengthened. It can be further seen from FIG. 6 that, since the pixel electrodes and the common electrodes are arranged alternately, the directly opposite area between the electrodes can be increased. Therefore, the horizontal electric field in the space can be strengthened, and thus the driving voltage of the blue phase liquid crystal can be reduced.

It should be noted that, the shape of the electrodes is not restricted by the above embodiments. The electrodes can have a curved surface according to the structure of the film layer, or can have a cylinder shape, a cube shape, a trapezoid shape, and so on. The similar structures of the electrodes all fall within the scope of the present embodiment, and the details of which are no longer repeated here.

In addition, it can be understood that, the simple combinations of the aforesaid embodiments and the adaptive changes thereof all fall within the scope of the present disclosure. For example, the structure as shown in FIG. 2 can be combined with the structure as shown in FIG. 3, and other examples will not be illustrated here.

According to the present disclosure, the strength of the electric field, especially the horizontal component of the electric field can be increased through increasing the surface area of the electrodes, increasing the directly opposite area between the electrodes, and reducing the distance between the electrodes, so that the driving voltage of the blue phase liquid crystal can be reduced. Further, the curved film layers according to the embodiments of the present disclosure are easy to be manufactured, and the procedure for manufacturing the substrate will not be increased apparently. The curved film layers can be manufactured by a multi-tone photomask through one patterning procedure. The manufacturing procedure will be illustrated below taking the manufacturing of the lower substrate as shown in FIG. 2 as an example.

The material of the curved film layer is generally selected to be the material of the protection layer or the passivation layer, such as SiNₓ, SiO₂, or organic resin. The above materials all have a good insulation performance, and can be formed and processed easily. The curved film layer can be formed through patterning after the basic structures of the substrate are formed, as shown in FIG. 7.

FIG. 7 is a flow chart of a method for manufacturing a substrate of the blue phase liquid crystal display panel according to the embodiment of the present disclosure. The method comprises the following steps. In step S710, a first organic film layer is deposited on a prefabricated lower substrate. In step S720, a first curved film layer is formed through patterning the first organic film layer. In step S730, the first curved film layer is coated with a common electrode. In step S740, a second organic film layer is deposited on the common electrode. In step S750, the second organic film layer is coated with an electrode material layer and the pixel electrodes are formed through patterning.

It should be noted that, the first organic film layer is used for forming a protection layer covering other prefabricated structures of the lower substrate, and the second organic film layer is used for forming an insulation layer between the pixel electrodes and the common electrode. The first organic film layer and the second organic film layer are formed through two steps, and the specific implementations thereof can be performed according to the manufacturing procedure in the prior art. The details of which are no longer repeated here.

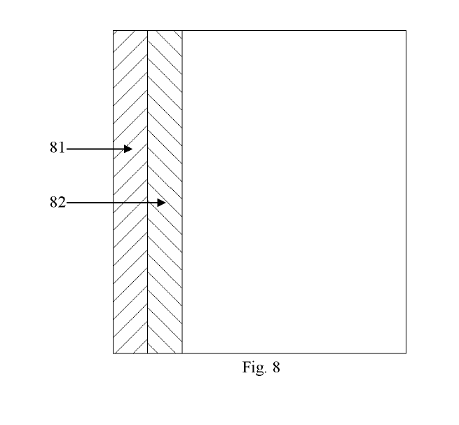

Further, the curved film layer is formed by a multi-tone photomask through patterning, and the multi-tone photomask according to the embodiment of the present disclosure is shown in FIG. 8. The multi-tone photomask comprises a plurality of density regulation regions 81 and a plurality of size regulation regions 82 that are arranged alternately, wherein the density regulation regions 81 can perform fine processing through changing the density of the lattices in the area, and the size regulation regions 82 can perform large size processing (such as the thickness) through changing the size of the lattices in the area.

Specifically, the etching depth of the protrusions of the curved film layer is less than that of the depressions of the curved film layer. Therefore, the protrusions of the curved film layer are formed by the density regulation regions of the multi-tone photomask through patterning, and the depressions of the curved film layer are formed by the size regulation regions of the multi-tone photomask through patterning. The inclined surfaces between the protrusions and the depressions can be processed through the gradually changing density or size of the lattices.

According to the aforesaid method for manufacturing the curved film layer, only one patterning procedure is added to the procedure in the prior art. The method is simple and easy to be performed, which would facilitate the popularization and application.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A blue phase liquid crystal display panel, comprising an upper substrate and a lower substrate,
wherein the lower substrate and the upper substrate are respectively provided with a first curved film layer and a second curved film layer matching with each other, and the first curved film layer and the second curved film layer are provided with protrusions and depressions arranged alternately on two opposite surfaces thereof, the two opposite surfaces being parallel with each other;
wherein pixel electrodes are arranged between the first curved film layer and the second curved film layer, and a common electrode is arranged inside the first curved film layer or the second curved film layer; or
wherein the common electrodes and the pixel electrodes are arranged between the first curved film layer and the second curved film layer alternately.

2. The blue phase liquid crystal display panel according to claim 1, wherein the curved film layer is a wave-shaped curved film layer, a triangular teeth-shaped curved film layer, and/or a trapezoid teeth-shaped curved film layer.

3. The blue phase liquid crystal display panel according to claim 1, wherein the pixel electrodes are arranged on surfaces of protrusions or depressions of the first curved film layer, and the common electrode is arranged inside the first curved film layer.

4. The blue phase liquid crystal display panel according to claim 1, wherein the pixel electrodes are arranged on surfaces of protrusions or depressions of the second curved film layer, and the common electrode is arranged inside the second curved film layer.

5. The blue phase liquid crystal display panel according to claim 1, wherein the pixel electrodes are arranged on surfaces of both protrusions and depressions of the first curved film layer, and the common electrode is arranged inside the first curved film layer.

6. The blue phase liquid crystal display panel according to claim 1, wherein the pixel electrodes are arranged on surfaces of both protrusions and depressions of the second curved film layer, and the common electrode is arranged inside the second curved film layer.

7. The blue phase liquid crystal display panel according to claim 1, wherein the pixel electrodes are arranged on inclined surfaces at two sides of protrusions or depressions of the first curved film layer, and the common electrode is arranged inside the first curved film layer.

8. The blue phase liquid crystal display panel according to claim 1, wherein the pixel electrodes are arranged on inclined surfaces at two sides of protrusions or depressions of the second curved film layer, and the common electrode is arranged inside the second curved film layer.

9. The blue phase liquid crystal display panel according to claim 1, wherein the pixel electrodes are arranged on inclined surfaces at two sides of both protrusions and depressions of the first curved film layer, and the common electrode is arranged inside the first curved film layer.

10. The blue phase liquid crystal display panel according to claim 1, wherein the pixel electrodes are arranged on inclined surfaces at two sides of both protrusions and depressions of the second curved film layer, and the common electrode is arranged inside the second curved film layer.

11. The blue phase liquid crystal display panel according to claim 1, wherein the pixel electrodes and the common electrodes are arranged on surfaces of protrusions or depressions of the first curved film layer alternately.

12. The blue phase liquid crystal display panel according to claim 1, wherein the pixel electrodes and the common electrodes are arranged on surfaces of protrusions or depressions of the second curved film layer alternately.

13. The blue phase liquid crystal display panel according to claim 1, wherein the pixel electrodes and the common electrodes are arranged on surfaces of both protrusions and depressions of the first curved film layer alternately.

14. The blue phase liquid crystal display panel according to claim 1, wherein the pixel electrodes and the common electrodes are arranged on surfaces of both protrusions and depressions of the second curved film layer alternately.

15. The blue phase liquid crystal display panel according to claim 1, wherein the pixel electrodes and the common electrodes are arranged on inclined surfaces at two sides of protrusions or depressions of the first curved film layer alternately.

16. The blue phase liquid crystal display panel according to claim 1, wherein the pixel electrodes and the common electrodes are arranged on inclined surfaces at two sides of protrusions or depressions of the second curved film layer alternately.

17. The blue phase liquid crystal display panel according to claim 1, wherein the pixel electrodes are arranged on surfaces of protrusions of the first curved film layer, and the common electrodes are arranged on surfaces of protrusions of the second curved film layer correspondingly.

18. The blue phase liquid crystal display panel according to claim 1, wherein the first curved film layer is formed by an organic film layer through patterning.

19. The blue phase liquid crystal display panel according to claim 1, wherein the curved film layer is made of SiNₓ, SiO₂, or organic resin.

20. The blue phase liquid crystal display panel according to claim 1, wherein the curved film layer is formed by a multi-tone photomask through patterning; and
wherein the protrusions of the curved film layer are formed by density regulation regions of the multi-tone photomask through patterning, and the depressions of the curved film layer are formed by size regulation regions of the multi-tone photomask through patterning.
